(19) United States
(12) Patent Application Publication
(10) Pub. No.: US 2003/0123734 A1
(43) Pub. Date: Jul. 3, 2003

(54) Methods and apparatus for object recognition

(75) Inventors: Dongge Li, Ossining, NY (US); Nevenka Dimitrova, Yorktown Heights, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/034,659

(22) Filed: Dec. 28, 2001

(51) Int. Cl. G06K 9/46

(52) U.S. Cl. 382/190

(57) ABSTRACT

A processing system is provided that detects an object of interest. The system receives an input image of the object. At least one feature is extracted from the input image. The extracted feature is then used to determine a set of candidate models by filtering out image models that do not contain the extracted feature. A sample image template is then formed based on a candidate sample image. The object of interest is then detected by comparing the input image to the sample image template. In a preferred embodiment, the formation of the template further includes calculating a parameter, such as direction, expression, articulation or lighting, of the object.

### FIELD OF INVENTION

The present invention relates generally to the field of object recognition, and more particularly to techniques and/or systems for recognizing an object of interest based on extraction of features and parameters from the object that can be utilized in generating a template against which a corresponding input image is compared.

### BACKGROUND OF INVENTION

Object recognition has many commercial applications and, therefore, has attracted much attention in recent years. For example, various object recognition techniques have been developed for recognizing deformable objects such as human faces. The ability to mechanically recognize a human face is an important challenge and has many diverse applications.

Face recognition applications can be used, for example, by security agencies, law enforcement agencies, the airline industry, the border patrol, the banking and securities industries and the like. Examples of potential applications include, but are not limited to, entry control to limited access areas, access to computer equipment, access to automatic teller terminals, and identification of individuals.

Conventional techniques for object recognition perform under strictly defined conditions and are based on a particular similarity comparison between an image of the object to be recognized and two-dimensional (2-D) templates with predetermined labels. These conventional techniques are therefore limited to the conditions (e.g. distance, lighting, actions, etc.) where the templates are captured or constructed.

Accordingly, there is a need for an improved object recognition system.

### SUMMARY OF THE INVENTION

The invention provides methods and apparatus for recognition of objects utilizing an image signal.

In accordance with one aspect of the invention, a processing system detects an object of interest by first creating at least one image model. The image model is based at least in part on at least one sample image. An input image of the object of interest is then received from an image source. At least one feature is extracted from the input image. The extracted feature is utilized in determining a set of candidate models by filtering out models that do not contain the feature. A sample image template is then formed based at least in part on a candidate model.

In a preferred embodiment, the formation of the template further includes calculating at least one parameter of the object, based on cues obtained from an outside source(s). This calculation of parameters can lead to better construction of customized templates and, consequently, more accurate recognition results. The object of interest is then recognized by comparing the input image to the sample image template.

Unlike conventional object recognition systems that can only detect well positioned objects in a constrained environment, the system of the invention is able to recognize objects from video or other image signals taken in natural conditions. Thus, the system of the invention is available for more general applications. For example, the system is able to detect human faces in live video or TV programs, where faces to be identified can appear in various directions and/or at different distances.

The system may be adapted for use in any of a number of different applications, including, e.g., coder/decoder devices (codecs), talking head and other types of animation, or face recognition. More generally, the system can be used in any application which can benefit from the improved object recognition provided by the invention. In addition, the system can be used to compress live video or other images, such as human faces, using a very low bit rate, which makes it a suitable codec for a variety of wireless, internet or telecommunication applications.

### BRIEF DESCRIPTION OF THE DRAWINGS

FIG. 1 is a block diagram of an object recognition system in which the present invention may be implemented.

FIG. 2 is a flow diagram showing the operation of an exemplary object recognition technique in accordance with an illustrative embodiment of the invention.

FIG. 3 is a block diagram illustrating a preferred object recognition system in accordance with the invention.

### DETAILED DESCRIPTION OF THE INVENTION

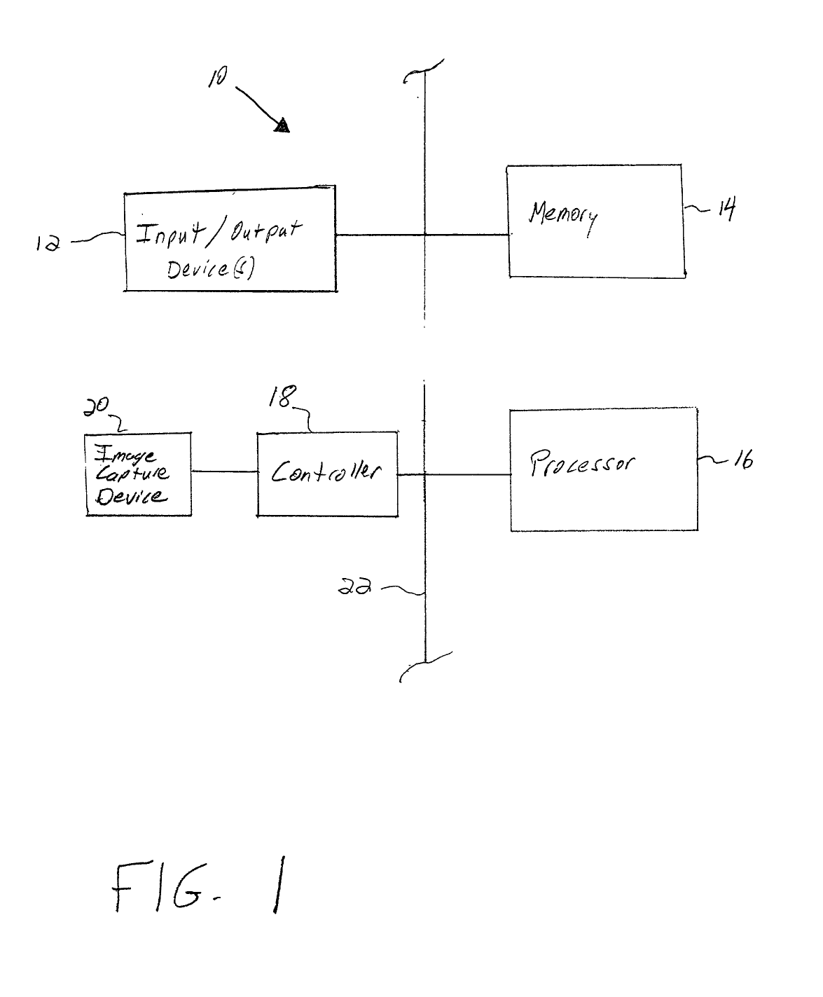

FIG. 1 shows an illustrative embodiment of an object recognition system 10 in accordance with the invention. The system 10 includes input/output device(s) 12, a memory 14, a processor 16, a controller 18, and an image capture device 20, all connected to communicate over a system bus 22.

Elements or groups of elements of the system 10 may represent corresponding elements of an otherwise conventional desktop or portable computer, as well as portions or combinations of these and other processing devices. Moreover, in other embodiments of the invention, some or all of the functions of the processor 16, controller 18 or other elements of the system 10 may be combined into a single device. For example, one or more of the elements of the system may be implemented as an application specific integrated circuit (ASIC) or circuit card to be incorporated into a computer or other processing device.

The term “processor” as used herein is intended to include a microprocessor, central processing unit, or any other data processing element that may be utilized in a given data processing device. In addition, it should be noted that the memory 14 may represent an electronic memory, an optical or magnetic disk-based memory, a tape-based memory, as well as combinations or portions of these and other types of storage devices.

In accordance with the present invention, the object recognition system 10 is configured to process images so as to recognize objects, e.g. faces, taken in natural conditions, based upon stored image information. For example, the system is able to recognize human faces in live video or television programs, where faces to be identified can appear in various directions and/or at different distances.

In an illustrative embodiment of the invention, sample images can be utilized to create an image model of the object to be detected. The image model created using the sample images is formed by known means. See, e.g., C. Bregler, M. Covell, and M. Stanley, “Video Rewrite: Driving Visual Speech With Audio,” Proc. ACM SIGGRAPH 97, in Computer Graphics Proceedings, Annual Conference Series (1997), incorporated herein by reference. The image model can be, for example, a single sample image, a 2-D model, or a 3-D model and can be stored in memory 14. The creation of the image model can be created “offline” or within the processor 16.

An input image of the object is received by the system 10 from the image capture device 20. At least one signature feature is extracted from the input image. Signature features are those features of the input image that are invariant to image conditions. Examples of such signature features are skin features, hair features, gender, age, etc. The signature feature is then utilized in filtering out any image model that does not contain the signature feature and, therefore, is not likely to match the input image. This initial elimination of image models can greatly improve the system's speed, robustness, and identification accuracy.

A set of candidate models is thus determined from the image models remaining. These candidate models are then used to generate sample image templates. The object is then detected based upon a comparison of the input image to each sample image template by conventional object/face recognition techniques.

In a preferred embodiment, the system is also able to make use of cues available from other media sources depicting the object of interest. The cues are used to calculate parameters of the object that can lead to better construction of the sample image template, and consequently, more accurate recognition results. It is preferred that the cue used in the parameter calculation of the object be obtained concurrently with the input image of the object obtained by the image capture device 20. For example, with audio or text information available, parameters can be built that can reflect the articulation or expression during the time the image is taken.

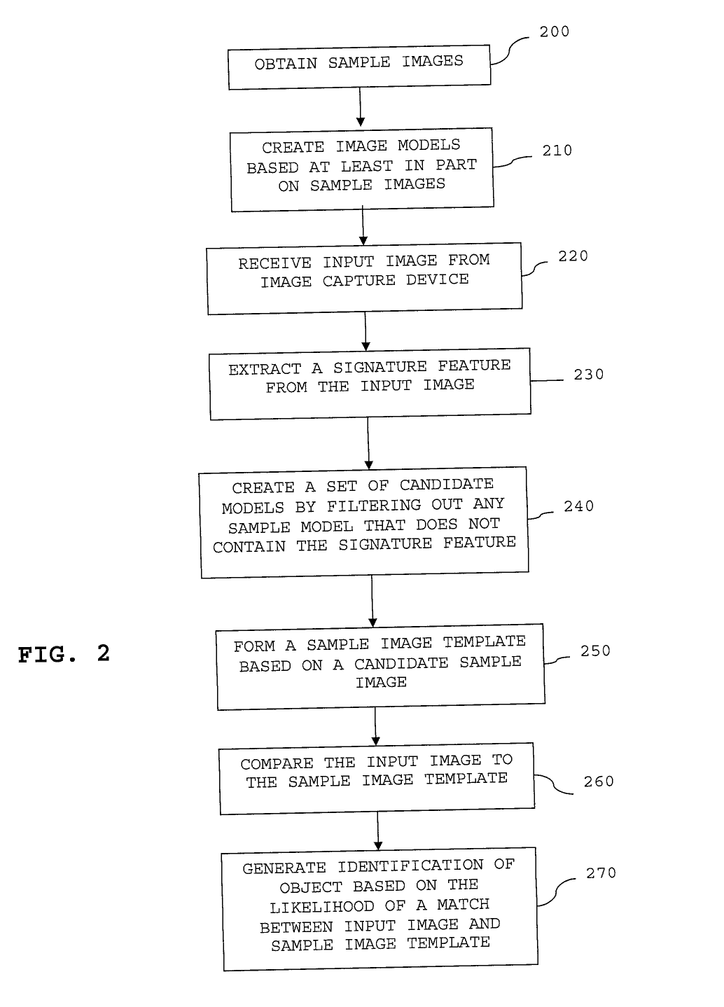

FIG. 2 is a flow diagram showing the steps for recognizing an object of interest in accordance with an illustrative embodiment of the present invention. In step 200 of FIG. 2, sample images are obtained. In step 210, image models are created based at least in part on the sample images. An image model can be the sample image itself, a 2-D model, or a 3-D model. The image model can be stored in memory 14. In step 220, an input image is received from an image capture device 20, such as a camera. At least one signature feature is then extracted from the input image in step 230 that can be used to filter out image models that do not contain the signature feature. In step 240, a set of candidate models are then determined by using the extracted feature to filter out any image model that does not contain the signature feature and, therefore, is unlikely to match the input image. In step 250, a sample image template is created based at least in part on a candidate model. In step 260, the input image is compared to the sample image template using visual content analysis (VCA), thereby enabling the generation of an identification of the object in step 270 based on the degree of likelihood of a match between the input image and sample image template.

The comparison between the input image and the sample image template in step 260 and generation of an identification in step 270 can be performed by conventional algorithms. For a detailed discussion of suitable VCA techniques, see, for example, Dongge Li, Gang Wei, Ishwar K. Sethi, and Nevenka Dimitrova, “Person Identification in TV Programs,” Journal of Electronic Imaging, 10(4):1-9 (October 2001); Nathanael Rota and Monique Thonnat, “Video Sequence Interpretation for Visual Surveillance,” in Proc. of the 3d IEEE Int'l Workshop on Visual Surveillance, 59-67, Dublin, Ireland (Jul. 1, 2000), and Jonathan Owens and Andrew Hunter, “Application of the Self-Organizing Map to Trajectory Classification,” in Proc. of the 3d IEEE Int'l Workshop on Visual Surveillance, 77-83, Dublin, Ireland (Jul. 1, 2000), all incorporated by reference herein. Generally, the techniques are employed to recognize various features in the image obtained by the image capture device 20.

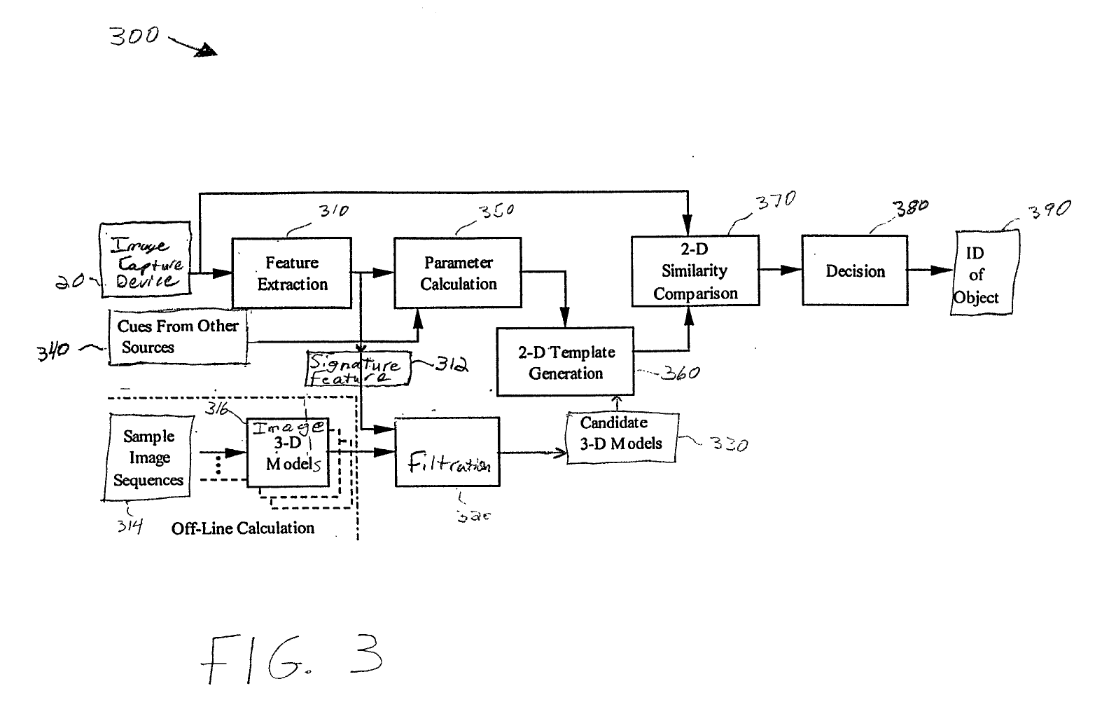

FIG. 3 shows a more detailed view of an object recognition process 300 that may be implemented in object recognition system 10 in accordance with the invention and that illustrates various preferred embodiments. In FIG. 3, the image capture device 20 provides an input image of the object to be detected. In step 310, feature extraction is performed on the input image as is known in the art. See R. Gonzales and R. Woods, Digital Image Processing, Addison-Wesley (1992), pages 416-429; and G. Wei, and I. Sethi, “Omni-Face Detection For Video/Image Content Description,” ACM Multimedia Workshops (2000), both incorporated herein by reference. Feature extraction can include, for example, edge detection, image segmentation, or detection of skin tone area. Parameter calculation 350 is then performed based on feature extraction 310, as is known in the art.

In a preferred embodiment, sample image sequences 314 are utilized to create three-dimensional (3-D) models in an off-line calculation. For example, 3-D models can be constructed using an x-axis corresponding to a facial plane defined by the far corners of the eyes and/or mouth, a y-axis along the symmetry axis of the facial plane, and the z-axis corresponding to the distance between the nose tip and the nose base. A. H. Gee and R. Cipolla, “Determining the Gaze of Faces in Images,” Image and Vision Computing, 12:639-647(1994), incorporated herein by reference. 3-D models then undergo object filtration 320 utilizing an extracted signature feature(s) 312 insensitive to image-capturing conditions, as described above. 3-D models that do not contain the signature feature are filtered out, leaving candidate 3-D models 330 which remain.

In a preferred embodiment, cues 340 from sources other than the actual input image, such as from video, audio, or text sources, are used to calculate the parameters of the object to be detected 350. Such parameters can include, for example, directional parameters, expression, articulation, and lighting conditions. Parameter calculation of the object is performed by conventional techniques. See, e.g., A.H. Gee and R. Cipolla, “Determining the Gaze of Faces in Images,” Image and Vision Computing, 12:639-647(1994), incorporated by reference herein. 2-D templates can then be generated based upon the candidate 3-D models and the calculated parameters 350 as is known in the art.

The following scenario is presented as an example of parameter calculation based on a textual outside cue. An individual to be detected may be walking through an airport security checkpoint. Before the individual reaches the checkpoint, it may be known that the individual is wearing a hat. This text, i.e. “wearing a hat” could be factored into the generation of the 2-D template by excluding 3-D candidate models of individuals without a hat.

Similarly, audio of an individual to be detected may be available and used in parameter calculations. See, D. Li, I. Sethi, N. Dimitrova, and T. McGee, “Classification of General Audio Data for Content-Based Retrieval,” Pattern Recognition Letters (2000); and C. Bregler, M. Covell, and M. Stanley, “Video Rewrite: Driving Visual Speech With Audio,” Proc. ACM SIGGRAPH 97, in Computer Graphics Proceedings, Annual Conference Series (1997), both incorporated herein by reference. Parameter calculations can be made using such audio in at least two ways. First, the audio may be utilized to calculate facial measurement parameters that can then be utilized in the generation of the 2-D template. Second, the audio can be utilized to identify an emotion (e.g. happiness) that can be utilized to manipulate the 3-D models in generating a more accurate 2-D template.

Video of the object to be identified can also be used in calculating parameters of the object. For example, if video of an individual is available, parameter calculations of the person's face can be made that can assist in generating a 2-D template from a 3-D model.

2-D similarity comparison 370 can then be performed between the input image from the image source 20 and the 2-D template using conventional recognition techniques. A decision 380 is then made regarding the identification or recognition of the object 390 based upon the degree of closeness of a match between the input image of the object and the 2-D template.

The invention can be implemented at least in part in the form of one or more software programs which are stored on an electronic, magnetic or optical storage medium and executed by a processing device, e.g., by the processor 16 of system 10.

The block diagram of the system 10 shown in FIG. 1, the operation of an object recognition technique in accordance with the invention shown in FIG. 2, and the preferred object recognition process 300 shown in FIG. 3, are by way of example only, and other arrangements of elements can be used. It is to be understood that the embodiments and variations shown and described herein are merely illustrative of the principles of this invention and that various modifications may be implemented by those skilled in the art without departing from the scope and spirit of the invention.

What is claimed is:

1. A method for recognizing an object of interest in a processing system, the method comprising:
creating at least one image model based at least in part on at least one sample image;
receiving an input image of said object;
extracting at least one signature feature from said input image;
determining a set of candidate models based at least in part on filtering out any image model that does not contain said at least one extracted feature;
forming a sample image template based at least in part on a candidate model;
recognizing the object of interest based at least in part on comparing said input image to said sample image template.

2. The method of claim 1 wherein the object of interest comprises a person.

3. The method of claim 1 wherein said image model is a two dimensional model or three dimensional model.

4. The method of claim 1 wherein said candidate model is a two dimensional model or three dimensional model.

5. The method of claim 1 wherein said signature feature is selected from the group consisting of skin features, hair features, age, gender, or a combination thereof.

6. The method of claim 1 wherein said sample image template is a two-dimensional template.

7. The method of claim 1 wherein said method further comprises performing feature extraction upon receipt of the input image.

8. The method of claim 1 wherein said formation of a sample image template further comprises calculating at least one parameter of said object.

9. The method of claim 8 wherein said parameter is selected from the group consisting of direction, expression, articulation, lighting, or a combination thereof.

10. The method of claim 8 wherein said parameter is calculated based upon a cue obtained from an outside source.

11. The method of claim 10 wherein said outside source is selected from the group consisting of an audio source, a video source, a text source, or combinations thereof.

12. An apparatus for recognizing an object of interest in a processing system , the apparatus comprising:
an image capture device; and
a processor coupled to the image capture device and operative (i) to receive an input image of said object; (ii) to extract at least one signature feature from said input image; (iii) to determine a set of candidate models at least in part by filtering out image models that do not contain said at least one extracted feature; (iv) to form a sample image template based at least in part on a candidate model; and (v) to detect the object of interest based at least in part on comparing said input image to said sample image template.

13. An apparatus for recognizing an object of interest in a processing system, the apparatus comprising:
a processor coupled to a memory and operative (i) to receive an input image of said object; (ii) to extract at least one signature feature from said input image; (iii) to determine a set of candidate models at least in part by filtering out image models that do not contain said at least one extracted feature; (iv) to form a sample image template based at least in part on a candidate model; and (v) to detect the object of interest based at least in part on comparing said input image to said sample image template.

14. An article of manufacture comprising a storage medium for storing one or more programs for recognizing an object of interest in a processing system, wherein the one or more programs when executed by a processor implement the steps of:
receiving an input image of said object;
extracting at least one feature from said input image;
determining a set of candidate models based at least in part by filtering out image models that do not contain said at least one extracted feature;
forming a sample image template based at least in part on a candidate model;
recognizing the object of interest based at least in part on comparing said input image to said sample image template.
